(19) United States
(12) Patent Application Publication
(10) Pub. No.: US 2016/0101470 A1
(43) Pub. Date: Apr. 14, 2016

(54) THREE-DIMENSIONAL FORMING APPARATUS AND THREE-DIMENSIONAL FORMING METHOD

(71) Applicant: SEIKO EPSON CORPORATION, Tokyo (JP)

(72) Inventor: Tomoyuki KAMAKURA, Matsumoto-shi (JP)

(21) Appl. No.: 14/877,641

(22) Filed: Oct. 7, 2015

(30) Foreign Application Priority Data
Oct. 8, 2014 (JP) 2014-206971

(51) Int. Cl. B22F 3/105

(52) U.S. Cl. CPC B22F 3/1055; B33Y 30/00

(57) ABSTRACT

A three-dimensional forming apparatus includes: a material supply unit that arranges a green sheet obtained by forming a sintering material in which metal powder and a binder are kneaded into a sheet shape on a stage; a first heating unit that supplies first energy transpiring a part of the green sheet; a second heating unit that supplies second energy capable of sintering a part of the green sheet; and a driving unit that is able to move the first heating unit and the second heating unit three-dimensionally relative to the stage, wherein the first energy is supplied from the first heating unit to the green sheet so that a sintering region to be sintered with the second energy supplied from the second heating unit in the green sheet supplied to the stage by the material supply unit is surrounded.

### CROSS-REFERENCE TO RELATED APPLICATIONS

This application claims priority to Japanese Patent Application No. 2014-206971 filed on Oct. 8, 2014. The entire disclosures of Japanese Patent Application No. 2014-206971 is hereby incorporated herein by reference.

### BACKGROUND

1. Technical Field

The present invention relates to a three-dimensional forming apparatus and a three-dimensional forming method.

2. Related Art

In the related art, a method described in JP-A-2002-97532 is disclosed as a manufacturing method of simply forming a three-dimensional shape using a metal material. JP-A-2002-97532 discloses, as a method of forming a composite fabricated object of metal and ceramics, a method of superimposing a metal tape in which a metal fine powder is formed in a tape shape in a ceramics tape in which a ceramics fine powder is formed in a tape shape, radiating a laser beam from the metal tape so that the cross-sectional shape of the composite fabricated object is formed, melting the metal tape, and diffusing the ceramics in the metal to form the composite fabricated object.

A method described in JP-A-2008-184622 is also disclosed. In the method of manufacturing a three-dimensional fabricated object disclosed in JP-A-2008-184622, a metal paste including, a metal powder, a solvent, and an adhesive thickener in a raw material is formed into material layers in a layered state and used. A metal sintered layer or a metal melted layer is formed by radiating a light beam to the material layers in the layered state. Then, the sintered layers or the melted layers are stacked by repeating the forming of the material layers and the radiation of the light beam, and thus a desired three-dimensional fabricated object can be obtained.

In the methods of forming the composite fabricated object and the three-dimensional fabricated object described in JP-A-2002-97532 and JP-A-2008-184622, a part of the raw material is sintered or melted by radiating the laser to a fabrication region. However, since heat applied to the fabrication region is also transferred to the unsintered or unmelted raw material in the region other than the fabrication region, especially near a boundary with the fabrication region and an unnecessary sintered or melted portion remains in the margin of the fabrication region, there is a concern of a desired shape being rarely obtained precisely.

### SUMMARY

An advantage of some aspects of the invention is to obtain a three-dimensional fabricated object with a precise shape according to an apparatus and a method capable of radiating heat energy only to a desired shape region.

The invention can be implemented as the following forms or application examples.

### Application Example 1

A three-dimensional forming apparatus according to this application example includes: a material supply unit that arranges a green sheet obtained by forming a sintering material in which metal powder and a binder are kneaded into a sheet shape on a stage; a first heating unit that supplies first energy transpiring a part of the green sheet; a second heating unit that supplies second energy capable of sintering a part of the green sheet; and a driving unit that is able to move the first heating unit and the second heating unit three-dimensionally relative to the stage, in which the first energy is supplied from the first heating unit to the green sheet so that a sintering region to be sintered with the second energy supplied from the second heating unit in the green sheet supplied to the stage by the material supply unit is surrounded.

According to the three-dimensional forming apparatus of this application example, the precise sintering region can be formed by transpiring and removing the green sheet so that the sintering region to be sintered with the first energy, which is a part of the three-dimensional fabricated object, is surrounded. Accordingly, it is possible to form the precise three-dimensional fabricated object.

In this application example, the sintering in “capable of sintering” refers to transpiring of a binder of the supply material due to the supplied energy and metal bonding between the remaining metal powder by the supplied energy by supplying the energy to the supply material. In the present specification, a form of the melting and bonding of the metal powder will be described as sintering performed by supplying the energy and bonding the metal powder.

### Application Example 2

In the three-dimensional forming apparatus according to the application example described above, an output of the first energy is different from an output of the second energy.

According to this application example, it is possible to easily control and supply desired energy for transpiring and desired energy for sintering the green sheet which is a raw material.

### Application Example 3

In the three-dimensional forming apparatus according to the application example described above, the first heating unit and the second heating unit are laser radiation units.

According to this application example, it is possible to radiate the energy to a precise position, and thus it is possible to obtain the precise three-dimensional fabricated object. Further, it is possible to easily control an energy output.

### Application Example 4

A three-dimensional forming method according to this application example includes: supplying a green sheet obtained by forming a sintering material in which metal powder and a binder are kneaded into a sheet shape; forming a single layer by transpiring and removing a part of the green sheet through radiation of first energy to the green sheet to form a removed portion and by radiating second energy toward the green sheet and sintering a part of the green sheet to form a sintered portion; stacking the single layer formed in the forming of the single layer as a first single layer and stacking the single layer as a second single layer in the forming of the single layer; and removing an unsintered portion from a stacked body including a three-dimensional fabricated object in which the sintered portions are stacked by repeating the stacking of the single layer a predetermined number of times.

According to the three-dimensional forming method of this application example, an unintended portion is prevented from being sintered due to the radiation of the second energy in the sintering of the part of the green sheet. Therefore, by transpiring the part of the green sheet with the first energy in advance and forming the removed portion, it is possible to form a precise sintering region. Accordingly, it is possible to form the precise three-dimensional fabricated object.

By performing the forming of the single layer by causing the unsintered portion to remain and stacking the green sheet, the green sheet of the lower layer prevents the green sheet from being deformed in the gravity direction while the single layer is formed. Thus, it is possible to form the precise three-dimensional fabricated object.

### Application Example 5

In the three-dimensional forming method according to the application example described above, in the removing of the part of the green sheet, the removed portion is formed so that a region in which the sintered portion is formed in the sintering of the part of the green sheet is surrounded.

According to this application example, the material of the green sheet is removed from the circumference of the sintered portion in the sintering of the part of the green sheet. Thus, it is possible to obtain the precise three-dimensional fabricated object.

### Application Example 6

In the three-dimensional forming method according to the application example described above, the first energy and the second energy are lasers, and the first energy and the second energy are different in a laser output or a laser wavelength.

According to this application example, it is possible to radiate the energy to a precise position, and thus it is possible to obtain the precise three-dimensional fabricated object. Since the desired energy for transpiring the green sheet which is a raw material and the desired energy for sintering the green sheet can be easily controlled in the laser radiation unit, it is possible to obtain the three-dimensional fabricated object with high quality.

### Application Example 7

In the three-dimensional forming method according to the application example described above, the removing of the part of the green sheet includes forming a splitting portion that splits the unsintered portion to be removed in the removing of the unsintered portion into a plurality of pieces.

According to this application example, by splitting the unsintered portion to be broken and removed by the splitting portion, it is possible to easily remove the unsintered portion.

### Application Example 8

A three-dimensional forming apparatus according to this application example includes a material supply device serving as a material supply unit that arranges a green sheet obtained by forming a sintering material in which metal powder and a binder are kneaded into a sheet shape on a stage, the material supply device including a sheet holding unit holding the green sheet placed on a supply table and a supply driving unit moving the sheet holding unit relative to the supply table, in which a sintering device serving as a first heating unit that supplies first energy transpiring a part of the green sheet and a second heating unit that supplies second energy capable of sintering a part of the green sheet includes a base, a stage movable three-dimensionally relative to the base, and a heating device heating the green sheet transferred to the stage to be stacked, and in which the first energy is supplied from the first heating unit to the green sheet so that a sintering region to be sintered with the second energy supplied from the second heating unit in the green sheet supplied to the stage by the material supply unit is surrounded.

According to this three-dimensional forming apparatus of this application example, the precise sintering region can be formed by transpiring and removing the green sheet so that the sintering region to be sintered with the first energy, which is a part of the three-dimensional fabricated object, is surrounded. Accordingly, it is possible to form the precise three-dimensional fabricated object.

### Application Example 9

In the three-dimensional forming apparatus according to the application example described above, the sintering device includes a laser oscillator, a galvano device by which a laser beam from the laser oscillator is radiated to a predetermined radiation position, and a plurality of laser controllers controlling output energy of the laser beam with respect to the green sheet, and the galvano device includes a galvano mirror reflecting the laser beam and a mirror driving unit driving the galvano mirror to reflect the laser beam from the laser oscillator in a predetermined direction.

According to this application example, the green sheet can be heated with high efficiency, and thus a loss of the supplied energy and a heating time are reduced.

### Application Example 10

A three-dimensional forming apparatus according to this application example includes: a control unit that serves as a control mechanism controlling a stage, a laser oscillator, a galvano device, a laser controller, and a material supply device.

According to this three-dimensional forming apparatus of this application example, it is possible to control the stage, the laser oscillator, the galvano device, the laser controller, and the material supply device, for example, based on the fabrication data of the three-dimensional fabricated object output from a data output apparatus such as a personal computer. Thus, it is possible to obtain the three-dimensional fabricated object with high precision of a finished product.

### Application Example 11

In the three-dimensional forming apparatus according to the application example described above, the control unit includes a controller operating in cooperation with a driving controller of the stage, a driving controller of the laser oscillator, a driving controller of the galvano device, a driving controller of the laser controller, and a driving controller of the material supply device.

According to this application example, the driving controller of the stage, the driving controller of the laser oscillator, the driving controller of the galvano device, the driving controller of the laser controller, and the driving controller of the material supply device operate in a cooperative manner to be driven. Therefore, even in the forming of a complicated shape, it is possible to form the three-dimensional fabricated object with high efficiency.

### BRIEF DESCRIPTION OF THE DRAWINGS

The invention will be described with reference to the accompanying drawings, wherein like numbers reference like elements.

FIG. 1 is a schematic diagram illustrating the configuration of a three-dimensional forming apparatus according to a first embodiment.

FIGS. 2A to 2C are schematic diagrams illustrating an overview of an operation of the three-dimensional forming apparatus according to the first embodiment.

FIG. 3 is a schematic diagram illustrating the configuration of a three-dimensional forming apparatus according to a second embodiment.

FIG. 4 is a flowchart illustrating a three-dimensional forming method according to a third embodiment.

FIG. 5 is a schematic diagram illustrating the configuration of a green sheet forming apparatus.

FIGS. 6A and 6B are external perspective views and sectional views taken along the line C-C′ illustrated in the external perspective views for describing the three-dimensional forming method according to the third embodiment.

FIGS. 7A and 7B are external perspective views and sectional views taken along the line C-C′ illustrated in the external perspective views for describing the three-dimensional forming method according to the third embodiment.

FIGS. 8A and 8B are external perspective views and sectional views taken along the line C-C′ illustrated in the external perspective views for describing the three-dimensional forming method according to the third embodiment.

FIG. 9 is a sectional view illustrating a method of forming an overhang according to the third embodiment.

FIG. 10 is a flowchart illustrating a three-dimensional forming method according to a fourth embodiment.

FIG. 11A is an external perspective view illustrating a splitting portion forming process and a sectional view taken along the line D-D′ illustrated in the external perspective view and FIG. 11B is an external perspective view illustrating a state immediately before an unsintered portion removal process for describing the three-dimensional forming method according to the fourth embodiment.

### DESCRIPTION OF EXEMPLARY EMBODIMENTS

Hereinafter, embodiments of the invention will be described with reference to the drawings.

### First Embodiment

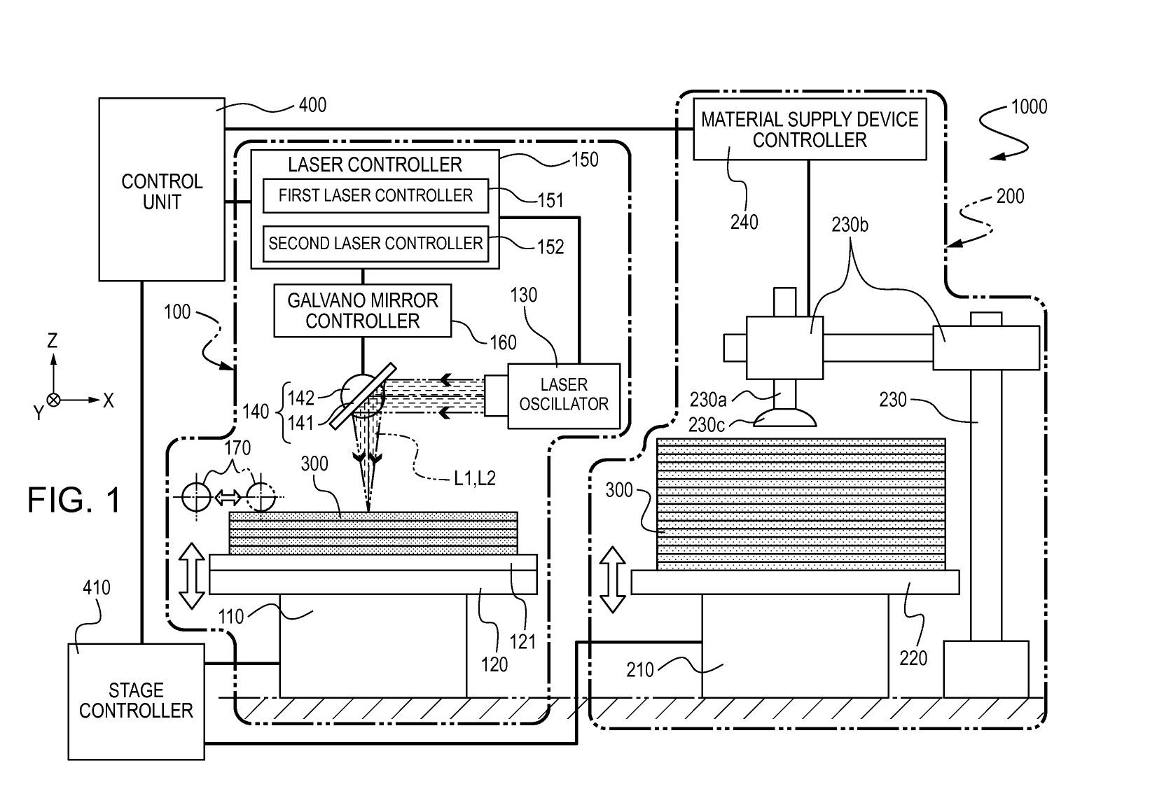

FIG. 1 is a schematic diagram illustrating the configuration of a three-dimensional forming apparatus according to a first embodiment. In the present specification, “three-dimensional forming” refers to forming a so-called stereoscopically fabricated object and includes, for example, forming a shape having a thickness even when the shape is a flat shape or a so-called two-dimensional shape.

A three-dimensional forming apparatus 1000 illustrated in FIG. 1 includes a sintering device 100 that forms a three-dimensional fabricated object and a material supply device 200 that supplies the sintering device 100 with a supply material 300 (hereinafter referred to as a green sheet 300) called a so-called green sheet in which a metal powder and a binder which are raw materials of the three-dimensional fabricated object are kneaded and formed in a sheet shape.

The material supply device 200 includes a supply base 210, a supply table 220 that is included to be able to be driven in the Z axis direction in an illustrated gravity direction by a driving unit (not illustrated) included in the supply base 210, and a transfer device 230 that holds one uppermost green sheet among a plurality of green sheets 300 loaded on the supply table 220 and transfers the green sheet to the sintering device 100.

The transfer device 230 includes a sheet holding unit 230a capable of holding the green sheet 300 and supply driving units 230b that move the sheet holding unit 230a relative to the supply table 220 at least in the X axis direction and the Y axis direction. The sheet holding unit 230a includes, for example, a sheet adsorption unit 230c which is a unit capable of holding and separating the green sheet 300 through decompression, suction, or the like, and thus can adsorb and hold the green sheet 300 using the sheet adsorption unit 230c. A method of holding the green sheet 300 of the sheet adsorption unit 230c is not limited to the above-described method. For example, when a raw metal is a magnetic substance, the green sheet may be mechanically held using a magnetic force adsorption method or the like or a pilot hole.

The sintering device 100 includes a base 110, a stage 120 that is included to be able to be driven in the illustrated Z axis direction with respect to the base 110 by a driving device (not illustrated) included in the base 110, and a sample plate 121 that is disposed on the stage 120 and has a heat resistance property to protect the stage 120 from heat energy from a heating mechanism to be described below. The green sheets 300 transferred from the material supply device 200 are stacked and disposed on the sample plate 121. In this example, for the green sheet 300 transferred and stacked in the uppermost layer, a press roller 170 that reciprocates in the X axis direction while pressing the green sheet 300 of the uppermost layer may be included in order to come into close contact with the green sheet 300 of the immediately lower layer. The press roller 170 preferably includes a unit that heats the green sheet 300 in order to improve adhesion between the upper and lower green sheets 300.

A laser oscillator 130 and a galvano device 140 by which a laser beam serving as a heating mechanism radiated from the laser oscillator 130 is radiated to a predetermined radiation position toward the green sheet 300 placed on the sample plate 121 are further included. The galvano device 140 and the driving device (not illustrated) included in the base 110 form a driving unit that can move the laser beam serving as the heating mechanism and the green sheet 300 on the sample plate 121 three-dimensionally relatively.

The galvano device 140 includes a galvano mirror 141 that reflects the laser beam and a mirror driving unit 142 that drives the galvano mirror 141 to reflect an optical axis of the laser beam from the laser oscillator 130 in a predetermined direction.

The three-dimensional forming apparatus 1000 includes a control unit 400 serving as a control mechanism that controls the stage 120, the supply table 220, the laser oscillator 130, the galvano device 140, and the transfer device 230 described above, for example, based on fabrication data for the three-dimensional fabricated object output from a data output device such as a personal computer (not illustrated). Although not illustrated in the drawing, the control unit 400 includes a driving control unit of the stage 120, a driving control unit of the supply table 220, a driving control unit of the laser oscillator 130, a driving control unit of the galvano device 140, a driving control unit of the transfer device 230, and a control unit controlling the driving in cooperation with the driving control units.

In regard to the stage 120 included to be able to be moved to the base 110 and the supply table 220 included to be able to be moved to the supply base 210, signals used to control movement start and stop, a movement direction, a movement amount, a movement speed, and the like of the stage 120 or the supply table 220 are generated based on control signals from the control unit 400 in a stage controller 410 and are transmitted to a driving device (not illustrated) included in the base 110 or the supply base 210 for driving.

In regard to the transfer device 230 included in the material supply device 200, signals used to control movement of the sheet holding unit 230a by the supply driving unit 230b included in the transfer device 230 and holding, separation, or the like of the green sheet 300 with respect to the sheet adsorption unit 230c are generated based on control signals from the control unit 400 in a material supply device controller 240, and thus the transfer of the green sheet 300 to the sintering device 100 is controlled.

In regard to the laser oscillator 130 and the galvano device 140, a laser controller 150 performing control such that at least energy of a different output is supplied to the green sheet 300 supplied to the stage 120 is included in the sintering device 100. The laser controller 150 includes at least a first laser controller 151 and a second laser controller 152.

A first heating unit is formed by the first laser controller 151 and a first laser beam L1 radiated as first energy from the laser oscillator 130 controlled by the first laser controller 151. A second heating unit is configured by the second laser controller 152 and a second laser beam L2 radiated as second energy from the laser oscillator 130 controlled by the second laser controller 152.

That is, one laser oscillator 130 can radiate the first laser beam L1 or the second laser beam L2 with a different output or wavelength toward the green sheet 300 by the two controllers, the first laser controller 151 and the second laser controller 152. Of course, a plurality of the laser oscillators 130 may be included and each laser oscillator may be configured to individually oscillate the first laser beam L1 or the second laser beam L2. The driving control of the galvano device 140 is performed such that a control signal is transmitted from the laser controller 150 to a galvano mirror controller 160 and a radiation direction of the laser beam L1 or L2 of the laser oscillator 130 is oriented to a predetermined position of the green sheet 300 for radiation.

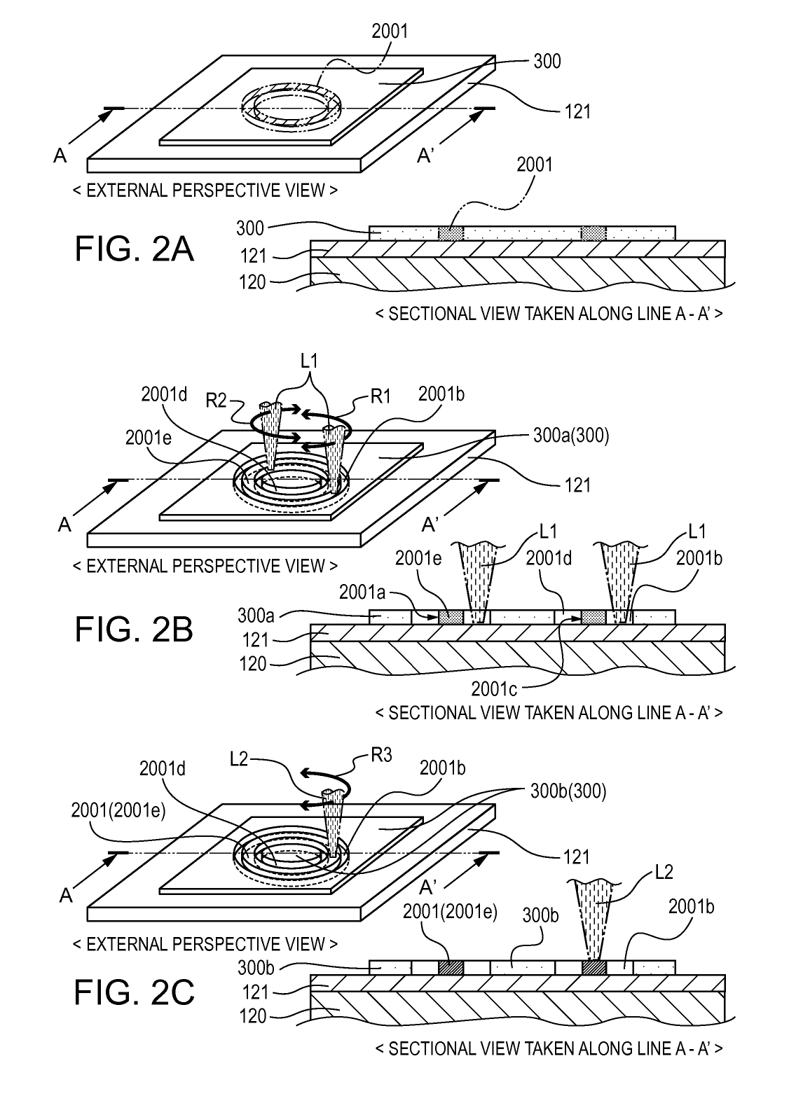

Next, an overview of an operation of the three-dimensional forming apparatus 1000 forming a three-dimensional fabricated object will be described with reference to FIGS. 2A to 2C. To facilitate the description, an operation performed at the time of forming of a circular fabricated object in one green sheet 300 placed on the sample plate 121 will be described. FIGS. 2A to 2C illustrate external perspective views illustrating the green sheet 300 placed on the sample plate 121 and sectional views taken along the line A-A′ illustrated in the external perspective views.

As illustrated in FIG. 2A, a formation schedule region of a circular partial fabrication object 2001 of a first layer which is a part of a three-dimensional fabricated object 2000 drawn in the placed green sheet 300 by two-dot chain lines (imaginary lines) is shown.

A laser emitted from the laser oscillator 130 is radiated toward the green sheet 300 illustrated in FIG. 2A via the galvano device 140 illustrated in FIG. 1. In the laser radiation, whether the first laser beam L1 or the second laser beam L2 is radiated is determined by an instruction from the control unit 400. In this example, the description will be made assuming that the first laser beam L1 is first radiated.

A signal for oscillating the first laser beam L1 is transmitted from the first laser controller 151 included in the laser controller 150 to the laser oscillator 130 based on an instruction of the control unit 400. Besides, a signal for driving control of the galvano device 140 starts to be generated in the galvano mirror controller 160 and the first laser beam L1 is emitted from the laser oscillator 130. Then, as illustrated in FIG. 2B, the first laser beam L1 is orbited along radiation routes R1 and R2 to be radiated by the galvano mirror 141 so that the first laser beam L1 is radiated to a predetermined region.

The first laser beam L1 has first energy with an output by which the metal powder and the binder included in the green sheet 300 can be transpired, and the green sheet 300 is partially removed so that a partially removed portion 2001b is formed along the outer circumference 2001a of a fabrication schedule region of the partial fabricated object 2001. Then, the green sheet 300 is partially removed so that a partially removed portion 2001d is formed along the inner circumference 2001c. A portion surrounded by the partially removed portion 2001b and the partially removed portion 2001d formed in this way is a fabrication raw material 2001e formed in the partial fabricated object 2001, and the green sheet 300a in a state in which the partially removed portions 2001b and 2001d are removed is obtained including the fabrication raw material 2001e.

Then, after the first laser beam L1 is radiated, a signal for oscillating the second laser beam L2 is transmitted from the second laser controller 152 included in the laser controller 150 to the laser oscillator 130 based on an instruction of the control unit 400. Besides, a signal for driving control of the galvano device 140 starts to be generated in the galvano mirror controller 160 and the second laser beam L2 is emitted from the laser oscillator 130. Then, as illustrated in FIG. 2C, the second laser beam L2 is orbited along a radiation route R3 to be radiated by the galvano mirror 141 so that the second laser beam L2 is radiated toward the fabrication raw material 2001e.

The second laser beam L2 has second energy with an output by which the metal powder can be bonded by transpiring the binder from the state in which the metal powder and the binder included in the green sheet 300 are kneaded, that is, a metal fabricated object can be formed through sintering. The second laser beam L2 is radiated to the fabrication raw material 2001e. Then, the fabrication raw material 2001e is sintered, so that the partial fabricated object 2001 is formed.

When the first laser beam L1 and the second laser beam L2 are radiated to the green sheet 300, the partially removed portions 2001b and 2001d are formed, and the partial fabricated object 2001 is formed, an unsintered region 300b for which none of the laser beams L1 and L2 are radiated to the green sheet 300 remains. Hereinafter, this region is referred to as an unsintered portion 300b in the green sheet 300.

As described above, the fabrication raw material 2001e with a precise shape is formed by the partially removed portions 2001b and 2001d, and the partial fabricated object 2001 with a precise shape is formed by sintering the fabrication raw material 2001e. Further, the second laser beam L2 radiated at this time, that is, the heat of the second energy, is not transferred to the unsintered portion 300b since the partially removed portions 2001b and 2001d serve as interruption portions. Thus, there is no concern of a partial sintering region being formed in the unsintered portion 300b. Accordingly, it is possible to easily perform a work of removing the finally removed unsintered portion 300b. Further, it is possible to suppress a loss of the raw material when the removed unsintered portion 300b is kneaded as the raw material again.

As described above, the three-dimensional forming apparatus 1000 according to the embodiment includes the laser oscillator 130 serving as the heating unit capable of supplying at least energy with different outputs and the galvano device 140 by which the laser beam radiated from the laser oscillator 130 is radiated to a predetermined radiation position toward the green sheet 300 placed on the sample plate 121. Thus, the single three-dimensional forming apparatus 1000 can efficiently perform different processes, that is, composite processes of the sintering process and the material removal process by the transpiring.

The first laser beam L1 and the second laser beam L2 described above are configured to be radiated toward a region to which the laser beams L1 and L2 are each expected to be radiated by the galvano device 140 by adjusting the output of the laser oscillator 130, but the invention is not limited thereto. For example, a plurality of laser oscillators, a laser oscillator radiating the first laser beam L1 and a laser oscillator radiating the second laser beam L2, may be mounted on arms of a double arm robot and the desired laser beams L1 and L2 may be configured to be radiated to a predetermined region by driving the arms.

The case has been exemplified in which the laser beam is used in the heating unit in the three-dimensional forming apparatus 1000 according to the first embodiment described above, but the invention is not limited thereto. For example, by blowing a hot wind to the green sheet 300 instead of the laser beam, the three-dimensional fabricated object 2000 can be formed. In this case, a hot wind ejecting unit for a temperature corresponding to the first energy and a hot wind ejecting unit for a temperature corresponding to the second energy may be included as units ejecting hot wind with different temperatures. Alternatively, hot wind with different temperatures may be ejected from a single hot wind ejecting unit.

### Second Embodiment

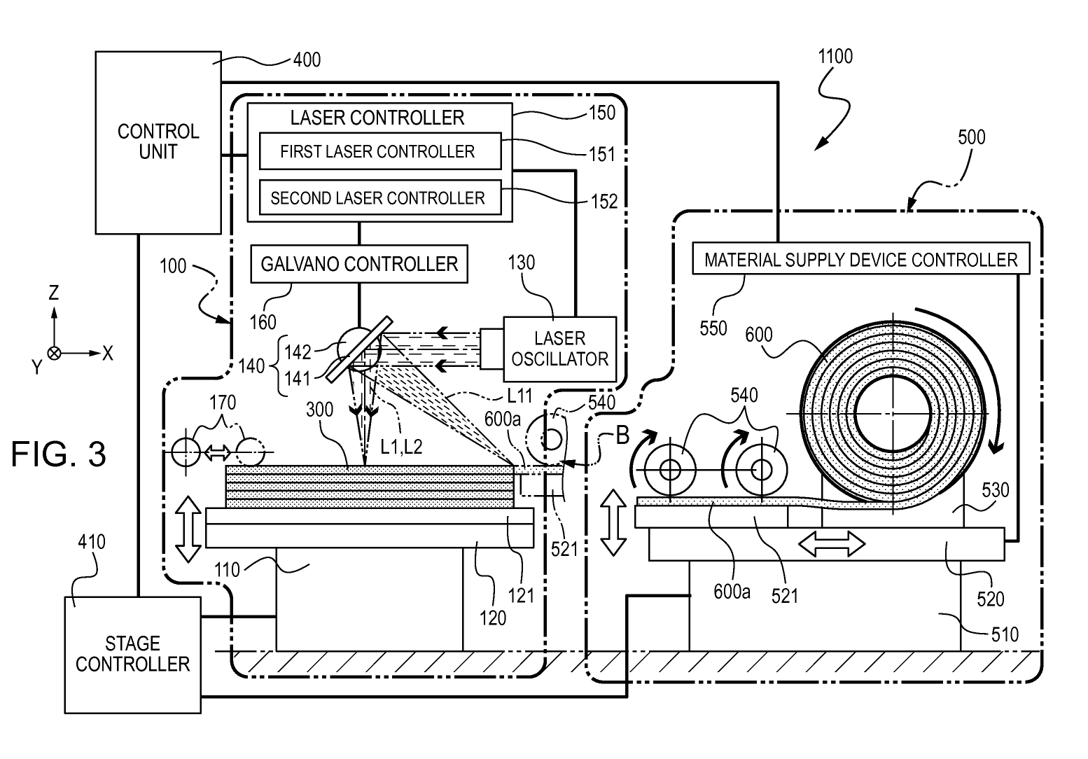

FIG. 3 is a schematic diagram illustrating the configuration of a three-dimensional forming apparatus 1100 according to a second embodiment. A three-dimensional forming apparatus 1100 according to the embodiment is different from the three-dimensional forming apparatus 1000 according to the first embodiment in the form of the material supply device 200, and the sintering device 100 has the same configuration. Therefore, the same reference numerals are given to the same constituent elements and the description thereof will be omitted.

A material supply device 500 included in the three-dimensional forming apparatus 1100 illustrated in FIG. 3 includes a supply base 510 and a supply table 520 that is included to be able to be driven in the Z axis direction along the illustrated gravity direction and approaching and receding directions to and from the sintering device 100 by a driving unit included in the supply base 510. The supply table 520 includes a roll holding unit 530 that rotatably holds a supply material roll 600 kneading the metal powder and the binder which are the raw materials of a three-dimensional fabricated object and forming a continuous sheet in a roll shape, a holding stand 521 that sends a continuous sheet 600a delivered from the supply material roll 600 toward the sintering device 100, and a delivery roller 540 that moves the continuous sheet 600a on the holding stand 521.

In the material supply to the sintering device 100, a control signal is transmitted from the control unit 400 to the stage controller 410, so that the supply table 520 is driven. The supply table 520 is moved up to a position at which the continuous sheet 600a can be delivered to the uppermost layer of the green sheet 300 stacked in the sintering device 100 in the Z axis direction and the X axis direction of a direction in which the sintering device 100 approaches the stage 120 in the state illustrated in FIG. 3 by a driving device (not illustrated), and then is held at an illustrated position B indicated by a two-dot chain line.

Then, the delivery roller 540 is driven based on a driving signal generated based on the control signal from the control unit 400 by a material supply device controller 550, so that the continuous sheet 600a is delivered to the uppermost layer of the green sheet 300 stacked in the sintering device 100. At this time, the roll holding unit 530 may be configured to be rotated freely in accordance with the delivery of the continuous sheet 600a delivered by the delivery roller 540, or may be configured such that a delivery amount of the delivered continuous sheet 600a is detected by a detection device (not illustrated) and may include a driving unit that rotates the supply material roll 600 by applying the delivery amount of the continuous sheet 600a.

When the continuous sheet 600a is delivered by a predetermined amount to the uppermost layer of the green sheet 300 stacked in the sintering device 100, the first laser beam L1 is instructed to be oscillated from the first laser controller 151 to the laser oscillator 130, the first laser beam L1 emitted from the laser oscillator 130 is reflected in the galvano device 140 and is radiated as a cutting laser beam L11 for cutting the continuous sheet 600a by a size corresponding to a predetermined green sheet 300 to the continuous sheet 600a, so that the continuous sheet 600a is cut out.

In the three-dimensional forming apparatus 1100 according to the embodiment, the green sheet 300 which is a supply material supplied to the sintering device 100 can be supplied to the sintering device 100 in accordance with the shape of a three-dimensional fabricated object so that the green sheet 300 has a necessary minimum size. Accordingly, it is possible to reduce waste of the material and to form a fabricated object with an improved material efficiency, that is, a product.

### Third Embodiment

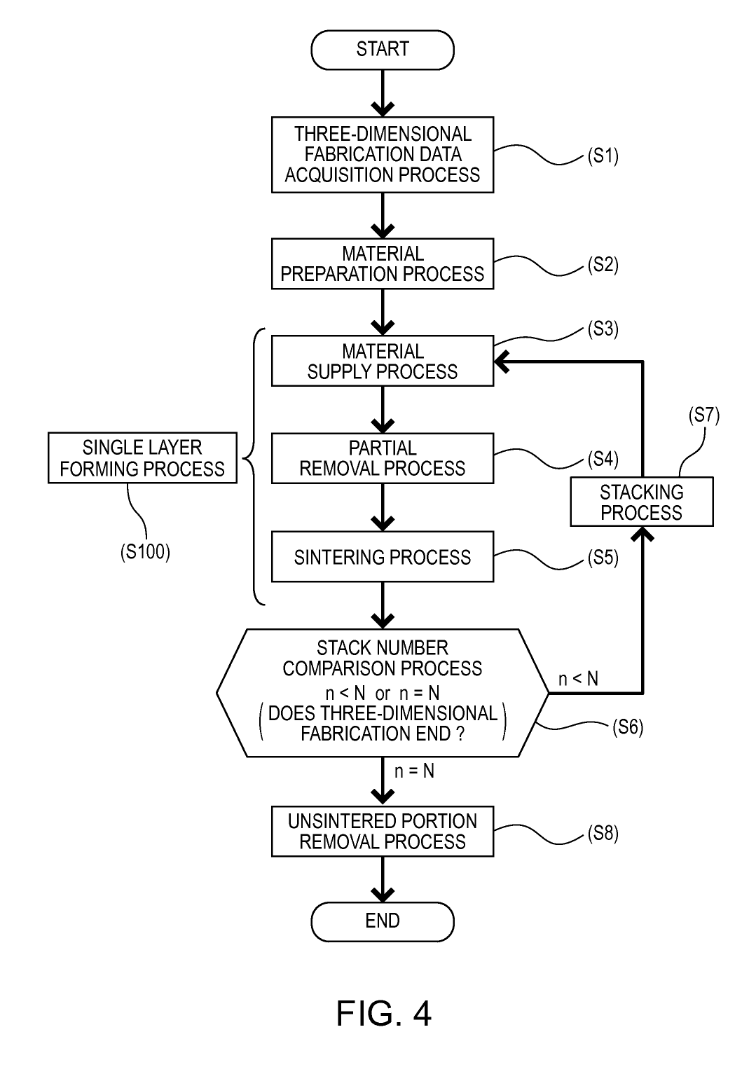

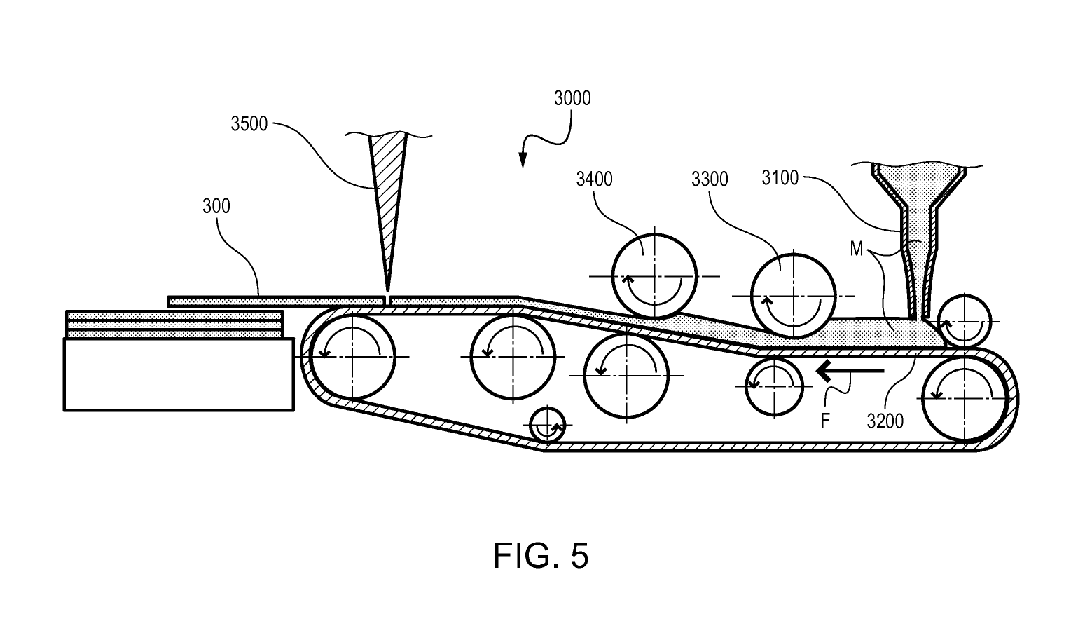

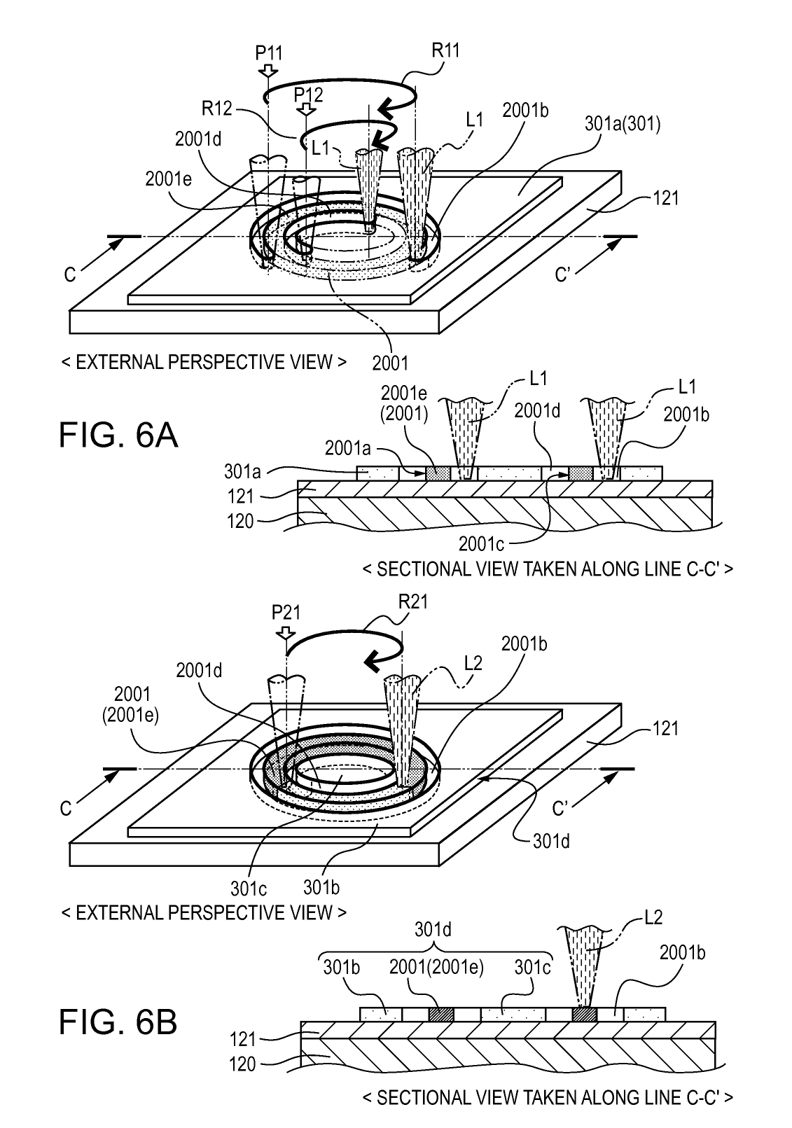

A three-dimensional forming method of forming a three-dimensional fabricated object using the three-dimensional forming apparatus 1000 according to the first embodiment will be described according to a third embodiment. FIG. 4 is a flowchart illustrating the three-dimensional forming method according to the third embodiment. FIG. 5 is a schematic diagram illustrating the configuration of a green sheet forming device forming the green sheet 300. FIGS. 6A to 8B are external perspective views and sectional views taken along the line C-C′ illustrated in the external perspective views for describing the three-dimensional forming method according to the third embodiment. In the embodiment, to facilitate the description, a method of forming a cylindrical three-dimensional fabricated object 2000 by forming a circular fabricated object in one green sheet 300 and stacking the fabricated objects will be described according to the embodiment.

### Three-Dimensional Fabrication Data Acquisition Process

As illustrated in FIG. 4, in the three-dimensional forming method according to the embodiment, a three-dimensional fabrication data acquisition process (S1) of acquiring three-dimensional fabrication data of the three-dimensional fabricated object 2000 from, for example, a personal computer (not illustrated) by the control unit 400 (see FIG. 1) is performed. In regard to the three-dimensional fabrication data acquired in the three-dimensional fabrication data acquisition process (S1), the control data is transmitted from the control unit 400 to the stage controller 410, the material supply device controller 240, and the laser controller 150, and then the process proceeds to a material preparation process.

### Material Preparation Process

In the material preparation process (S2), a predetermined number of green sheets 300 is placed on the supply table 220 included in the material supply device 200. The green sheet 300 is formed by a green sheet forming device 3000 or the like for the green sheet 300, as the schematic configuration is exemplified in FIG. 5.

As illustrated in FIG. 5, the green sheet forming device 3000 includes a raw material supply unit 3100 that supplies a raw material M and a transport belt 3200 that receives the raw material M discharged from the raw material supply unit 3100 and transports the raw material M. A mixture in which a metal powder formed with a size equal to or less than 30 μm and a binder are kneaded and formed in a paste form is used as the raw material M. As the metal powder, for example, an alloy such as a cobalt-based alloy, maraging steel, stainless steel, a titanium-based alloy, a nickel-based alloy, a magnesium alloy, or a copper-based alloy, or a metal such as iron, titanium, nickel, or copper can be used. As the binder, a thermoplastic resin or a thermoplastic water-soluble resin can be used. As the thermoplastic resin, for example, polylactic acid (PLA), polypropylene (PP), polyphenylene sulfide (PPS), polyamide (PA), ABS, or polyether ether ketone (PEEK) is used. As the thermoplastic water-soluble resin, for example, polyvinyl alcohol (PVA) or polyvinyle butyral (PVB) is used.

The raw material M in which the above-described metal powder and binder and a solvent for viscosity adjustment are added and kneaded is input to the raw material supply unit 3100, and a predetermined amount of raw material is sequentially discharged to the transport belt 3200 driven in an illustrated arrow F direction. With the movement of the transport belt 3200 in the F direction, the thickness of the raw material M is equalized by an equalizing roll 3300, the raw material M passes through a subsequent pressurization roller 3400 so that the raw material M has a predetermined thickness for the green sheet 300. Then, the raw material M is cut out in a predetermined length by a cutting unit 3500 to obtain the green sheet 300.

### Material Supply Process

When the predetermined number of green sheets 300 are placed on the supply table 220 of the material supply device 200 in the material preparation process (S2), a material supply process (S3) starts. In the material supply process (S3), the material supply device controller 240 generates a driving signal of the transfer device 230 based on a control signal from the control unit 400 and drives the transfer device 230.

First, the sheet holding unit 230a is moved up to a predetermined position, and the uppermost sheet of the green sheets 300 stacked on the supply table 220 is adsorbed and held by the sheet adsorption unit 230c. The sheet holding unit 230a is moved to the sample plate 121 of the sintering device 100 while holding the green sheet 300, the green sheet 300 is detached and separated from the sheet adsorption unit 230c, and the green sheet 300 is placed on the sample plate 121. After the green sheet 300 is placed and separated, the sheet holding unit 230a returns to a standby position of the material supply device 200. Hereinafter, the green sheet 300 placed as a first layer will be described as a first layer green sheet 301.

### Partial Removal Process

When the first layer green sheet 301 is placed on the sample plate 121, a partial removal process (S4) starts. As illustrated in FIG. 6A, the partial removal process (S4) is a process of removing a part of the first layer green sheet 301 so that a formation region of a circular partial fabrication object 2001 of a first layer which is a part of the three-dimensional fabricated object 2000 drawn in the placed first layer green sheet 301 by two-dot chain lines (imaginary lines) is surrounded.

In the partial removal process (S4), the first layer green sheet 301 of the region to which the first energy of the first laser beam L1 is radiated is transpired by radiating the first laser beam L1 illustrated in FIG. 1 toward the first layer green sheet 301 so that the first laser beam L1 is drawn in a predetermined trajectory by the galvano device 140. In the example illustrated in FIG. 6A, according to a control signal of the first laser controller 151, the first laser beam L1 is radiated from a radiation start point P11 to the radiation start point P11 along a radiation route R11 based on three-dimensional fabrication data to form a partially removed portion 2001b so that the outer circumference 2001a of the fabrication schedule region of the partial fabricated object 2001 is formed.

Next, the first laser beam L1 is radiated from a radiation start point P12 to the radiation start point P12 along a radiation route R12 based on three-dimensional fabrication data to form a partially removed portion 2001d so that the inner circumference 2001c of the fabrication schedule region of the partial fabricated object 2001 is formed. A portion surrounded by the partially removed portion 2001b and the partially removed portion 2001d formed in this way is the fabrication raw material 2001e of the partially fabricated object 2001, and a first layer green sheet 301a from which the partially removed portions 2001b and 2001d are removed is formed including the fabrication raw material 2001e. That is, in other words, the partially removed portions 2001b and 2001d are formed to surround the circumference of the fabrication raw material 2001e.

### Sintering Process

Next, the process proceeds to a sintering process (S5) in which the second laser beam L2 with the second energy is radiated to the fabrication raw material 2001e formed in the first layer green sheet 301a formed in the partial removal process (S4). The sintering in the sintering process (S5) is a processing mechanism of transpiring the binder from the state in which the metal powder and the binder included in the green sheet 300 are kneaded, bonding the metal powder, and forming a metal fabricated object from the metal powder state.

In the sintering process (S5), as illustrated in FIG. 6B, the second laser beam L2 is radiated toward the fabrication raw material 2001e formed in the partial removal process (S4) from a radiation start point P21 to the radiation start point P21 along a radiation route R21 based on three-dimensional fabrication data. The region of the fabrication raw material 2001e to which the second laser beam L2 is radiated is sintered with the second energy of the second laser beam L2, so that the partial fabricated object 2001 of the metal fabricated object is formed.

The fabrication raw material 2001e is sintered in the sintering process (S5) from the first layer green sheet 301a from which the partially removed portions 2001b and 2001d are removed in the partial removal process (S4), and thus the partial fabricated object 2001 is formed. The remaining regions, that is, an outside region 301b of the partially removed portion 2001b and an inside region 301c of the partially removed portion 2001d in this example, are regions to which none of the first laser beam L1 and the second laser beam L2 are radiated, that is, are unsintered regions. Hereinafter, the outside region 301b is referred to as a first unsintered portion 301b and the inside region 301c is referred to as a second unsintered portion 301c.

In this way, the sintered partial fabricated object 2001, the first unsintered portion 301b, and the second unsintered portion 301c are formed in the sintering process (S5), so that a first layer 301d is formed as a first single layer. The above-described series of processes from the material supply process (S3) to the sintering process (S5) is a single layer forming process (S100). Then, the sintering process (S5) ends, that is, the single layer forming process (S100) ends and the process proceeds to a subsequent stack number comparison process.

### Stack Number Comparison Process

When the first layer 301d including the partial fabricated object 2001 which is the first layer, the first unsintered portion 301b, and the second unsintered portion 301c is formed in the single layer forming process (S100), the process proceeds to a stack number comparison process (S6) of performing comparison with fabrication data obtained in the three-dimensional fabrication data acquisition process (S1). In the stack number comparison process (S6), a stack number N of the green sheets 300 in which partial fabricated objects are formed and which are necessary to form the three-dimensional fabricated object 2000 is compared to a stack number n of the green sheets 300 stacked up to the single layer forming process (S100) immediately before the stack number comparison process (S6). When n<N is determined in the stack number comparison process (S6), the process proceeds to a stacking process of performing the single layer forming process (S100) again.

### Stacking Process

A stacking process (S7) is an instruction process of performing the single layer forming process (S100) again when n<N is determined in the stack number comparison process (S6). The material supply process (S3) which is a start process of the single layer forming process (S100) is performed.

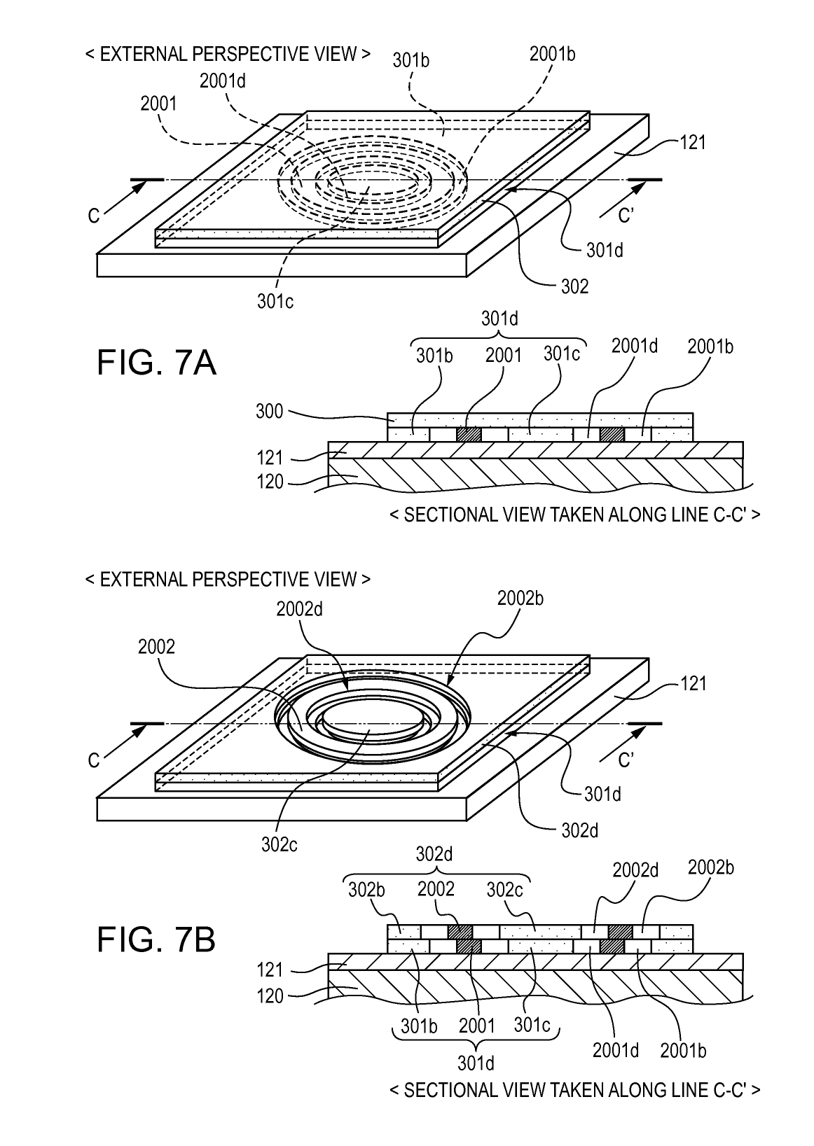

As illustrated in FIG. 7A, the green sheet 300 is supplied to be placed on the first layer 301d of the first layer through the stacking process (S7) and becomes a second layer green sheet 302 of a second layer.

Then, as illustrated in FIG. 7B, the partial removal process (S4) and the sintering process (S5) are performed on the second layer green sheet 302 of the second layer, so that a second layer 302d can be obtained as a second single layer in which partially removed portions 2002b and 2002d of the second layer, a partial fabricated object 2002, a first unsintered portion 302b, and a second unsintered portion 302c are formed. Thereafter, the process proceeds to the stack number comparison process (S6). When n<N is determined, the stacking process (S7) starts again. The stacking process (S7) and the single layer forming process (S100) are repeated until n=N is determined in the stack number comparison process.

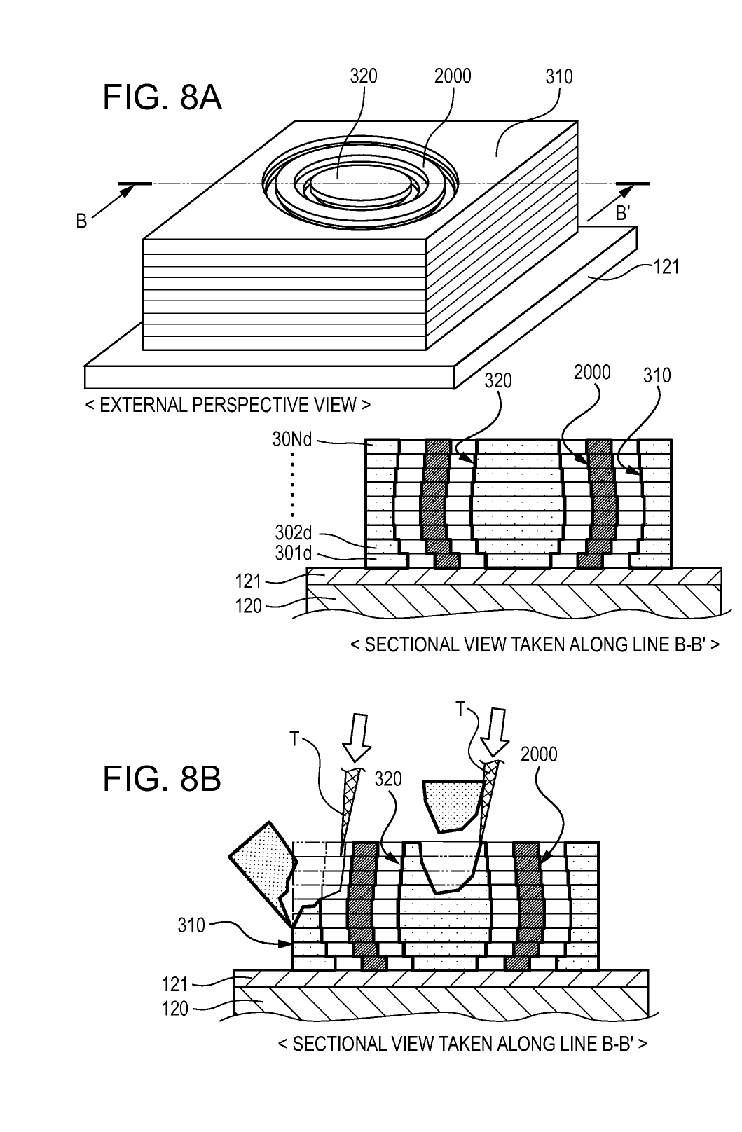

As illustrated in FIG. 8A, when the predetermined stack number N is stacked, the three-dimensional fabricated object 2000 is formed on the sample plate 121. First unsintered portions 310 and second unsintered portions 320 stacked to be formed from the first layer 301d to an N-th layer 30Nd are also formed on the sample plate 121. Then, when n=N is determined in the stack number comparison process (S6), the process proceeds to an unsintered portion removal process.

### Unsintered Portion Removal Process

An unsintered portion removal process (S8) is a process of removing portions excluding the three-dimensional fabricated object 2000, that is, the first unsintered portions 310 and the second unsintered portions 320. As the method of removing the unsintered portions 310 and 320, for example, a mechanical removal method or a method of dissolving the binder including the unsintered portions 310 and 320 using a solvent and removing the remaining metal powder can be applied. In the embodiment, the mechanical removal method will be described as an example.

As illustrated in FIG. 8B, in the unsintered portion removal process (S8), the unsintered portions 310 and 320 are removed from the sample plate 121 by striking the first unsintered portions 310 and the second unsintered portions 320 with a removal tool T with a wedge-shaped tip end and breaking the unsintered portions 310 and 320. Then, the three-dimensional fabricated object 2000 remains on the sample plate 121 and is extracted. In the embodiment, the case in which the unsintered portion removal process (S8) is performed on the sample plate 121 has been described, but the unsintered portion removal process may be performed on a separately provided work stand.

In the three-dimensional forming method for the three-dimensional fabricated object 2000 according to the above-described third embodiment, the partially removed portions 2001b and 2001d are formed to surround the fabrication raw material 2001e formed as the region in which the partial fabricated object 2001 is formed in the partial removal process (S4) included in the single layer forming process (S100). By forming the partially removed portions 2001b and 2001d in this way, a member transmitting heat generated by the second laser beam L2 is not present in the outer edge of the fabrication raw material 2001e when the fabrication raw material 2001e is sintered with the second laser beam L2 in the sintering process (S5). Therefore, it is possible to obtain the partial fabricated object with a precise shape, that is, the three-dimensional fabricated object 2000.

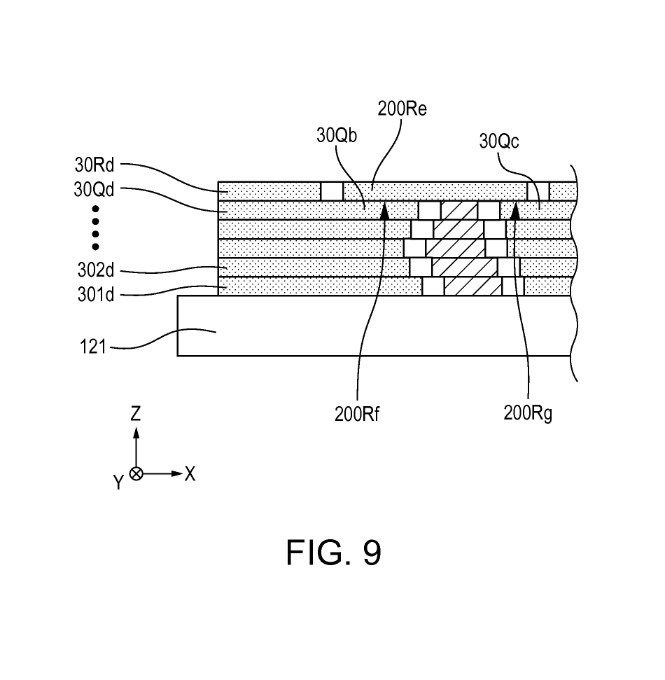

In the three-dimensional forming method according to the third embodiment, the unsintered portion removal process (S8) is performed after the predetermined stack number N is stacked. Therefore, as illustrated in FIG. 9, it is possible to prevent an overhang from being deformed in the gravity direction (a downward direction on the drawing along the illustrated Z axis).

For example, as illustrated in FIG. 9, in an R-th layer 30Rd between the first layer 301d and an N-th layer 30Nd excluding the first layer 301d, a fabrication raw material 200Re in which overhangs 200Rf and 200Rg are formed to the partial fabricated object of the lower layer is exemplified. In the R-th layer 30Rd, the binder which is an element of the green sheet 300 is softened due to the heat of the first laser beam L1 in the partial removal process (S4), and thus the overhangs 200Rf and 200Rg are easily plastically deformed in the gravity direction. However, the overhangs 200Rf and 200Rg are held by unsintered portions 30Qb and 30Qc remaining in a Q-th layer 30Qd present in the lower layer of the overhangs 200Rf and 200Rg, and thus the deformation in the gravity direction is hindered. Accordingly, it is possible to obtain the precise three-dimensional fabricated object 2000.

### Fourth Embodiment

A three-dimensional forming method according to a fourth embodiment will be described. The three-dimensional forming method according to the fourth embodiment is different in that a splitting portion forming process of splitting the unsintered portion 310 or the unsintered portion 320 removed in the unsintered portion removal process (S8) in advance is included in the partial removal process (S4) of the three-dimensional forming method according to the third embodiment. Accordingly, in the description of the three-dimensional forming method according to the fourth embodiment, the same reference numerals are given to the same constituent elements as those of the three-dimensional forming method according to the third embodiment, and the description thereof will be omitted.

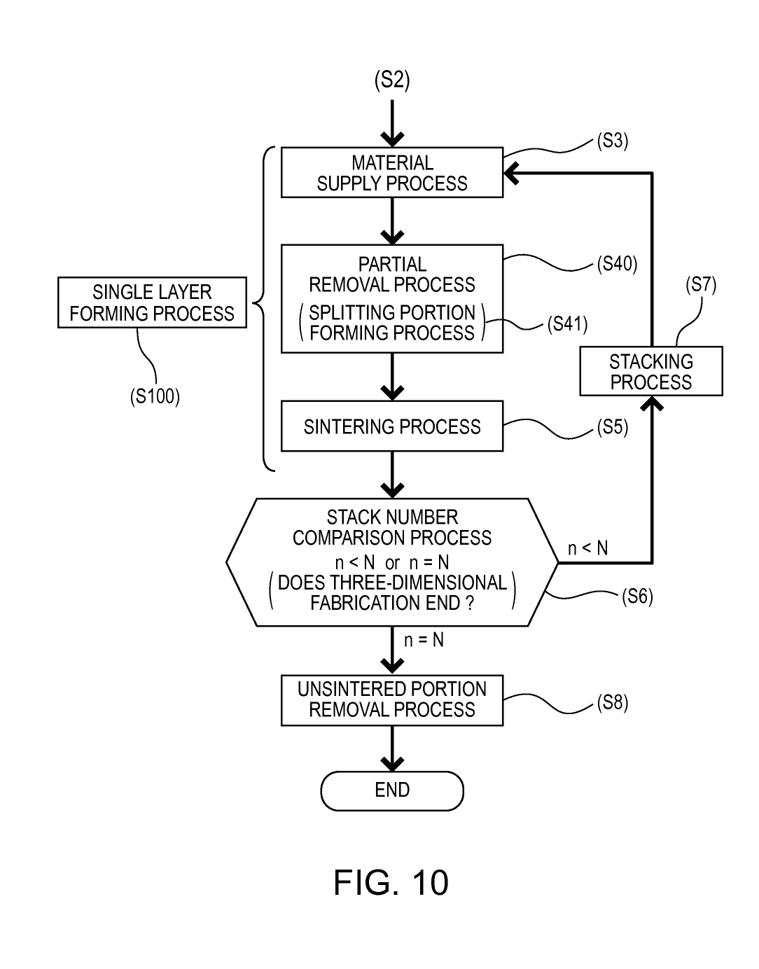

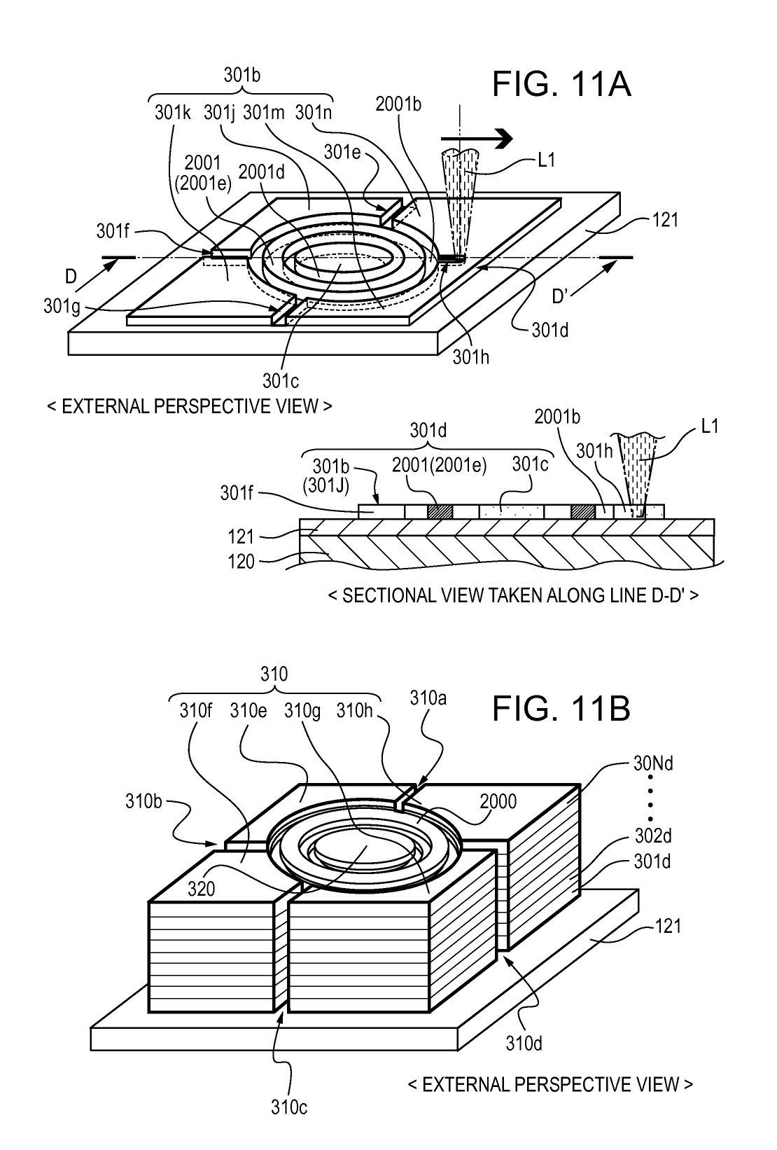

FIG. 10 is a flowchart including a partial removal process (S40) according to the fourth embodiment. The partial removal process (S40) according to the embodiment includes a splitting portion forming process (S41). FIG. 11A is an external perspective view and a sectional view taken along the line D-D′ illustrated in the external perspective view and FIG. 11B is an external perspective view for describing the three dimensional forming method according to the fourth embodiment.

### Partial Removal Process

In the partial removal process (S40) according to the embodiment, as illustrated in FIG. 11A, the first layer green sheet 301a in which the outside region 301b and the inside region 301c illustrated in FIG. 6A are formed is formed through the same process as the partial removal process (S4) according to the third embodiment.

### Splitting Portion Forming Process

A splitting portion forming process (S41) of transpiring and removing the element of the green sheet 300 is performed on the obtained outside region 301b of the first layer green sheet 301a by radiating the first energy of the first laser beam L1 to four regions, partially removed portions 301e, 301f, 301g, and 301h, in this example radially toward the outside from the partially removed portion 2001b, as illustrated in FIG. 11A. By forming the partially removed portions 301e, 301f, 301g, and 301h in the splitting portion forming process (S41), the outside region 301b is formed by splitting portions 301j, 301k, 301m, and 301n. That is, the partially removed portions 301e, 301f, 301g, and 301h are the splitting portions splitting the outside region 301b. Hereinafter, the partially removed portions 301e, 301f, 301g, and 301h are referred to as splitting portions 301e, 301f, 301g, and 301h.

After the partial removal process (S40) including the splitting portion forming process (S41) is performed, the stacking process (S7) and the single layer forming process (S100) are repeated as in the three-dimensional forming method according to the third embodiment. When n=N is determined in the stack number comparison process (S6), layers are formed up to an N-th layer 30Nd including the three-dimensional fabricated object 2000 immediately before the unsintered portion removal process (S8), as illustrated in FIG. 11B. Then, the splitting portions 301e, 301f, 301g, and 301h formed in each layer through the splitting portion forming process (S41) are stacked up to the N-th layer 30Nd to be formed in splitting portions 310a, 310b, 310c, and 310d. The first unsintered portion 310 is formed by split unsintered portions 310e, 310f, 310g and 310h split by the splitting portions 310a, 310b, 310c, and 310d.

In this way, the first unsintered portion 310 is formed by split unsintered portions 310e, 310f, 310g and 310h split by the splitting portions 310a, 310b, 310c, and 310d, and thus the removed portions can be easily broken in a subsequent unsintered portion removal process (S8).

In the above-described splitting portion forming process (S41), the case in which the outside region 301b is split into four portions has been described, but the invention is not limited thereto. The outside region may be split into two or more portions. Splitting portions may be formed in the inside region 301c, and splitting portions may be formed in both regions, the outside region 301b and the inside region 301c.

What is claimed is:

1. A three-dimensional forming apparatus comprising:
a material supply unit that arranges a green sheet obtained by forming a sintering material in which metal powder and a binder are kneaded into a sheet shape on a stage;
a first heating unit that supplies first energy transpiring a part of the green sheet;
a second heating unit that supplies second energy capable of sintering a part of the green sheet; and
a driving unit that is able to move the first heating unit and the second heating unit three-dimensionally relative to the stage,
wherein the first energy is supplied from the first heating unit to the green sheet so that a sintering region to be sintered with the second energy supplied from the second heating unit in the green sheet supplied to the stage by the material supply unit is surrounded.

2. The three-dimensional forming apparatus according to claim 1, wherein an output of the first energy is different from an output of the second energy.

3. The three-dimensional forming apparatus according to claim 1, wherein the first heating unit and the second heating unit are laser radiation units.

4. A three-dimensional forming method comprising:
supplying a green sheet obtained by forming a sintering material in which metal powder and a binder are kneaded into a sheet shape;
forming a single layer by transpiring and removing a part of the green sheet through radiation of first energy to the green sheet to form a removed portion and by radiating second energy toward the green sheet and sintering a part of the green sheet to form a sintered portion;
stacking the single layer formed in the forming of the single layer as a first single layer and stacking the single layer as a second single layer in the forming of the single layer; and
removing an unsintered portion from a stacked body including a three-dimensional fabricated object in which the sintered portions are stacked by repeating the stacking of the single layer a predetermined number of times.

5. The three-dimensional forming method according to claim 4, wherein in the removing of the part of the green sheet, the removed portion is formed so that a region in which the sintered portion is formed in the sintering of the part of the green sheet is surrounded.

6. The three-dimensional forming method according to claim 4,
wherein the first energy and the second energy are lasers, and
wherein the first energy and the second energy are different in a laser output or a laser wavelength.

7. The three-dimensional forming method according to claim 4, wherein the removing of the part of the green sheet includes forming a splitting portion that splits the unsintered portion to be removed in the removing of the unsintered portion into a plurality of pieces.

8. A three-dimensional forming apparatus comprising:
a material supply device serving as a material supply unit that arranges a green sheet obtained by forming a sintering material in which metal powder and a binder are kneaded into a sheet shape on a stage, the material supply device including
a sheet holding unit holding the green sheet placed on a supply table and
a supply driving unit moving the sheet holding unit relative to the supply table,
wherein a sintering device serving as a first heating unit that supplies first energy transpiring a part of the green sheet and a second heating unit that supplies second energy capable of sintering apart of the green sheet includes a base, a stage movable three-dimensionally relative to the base, and a heating device heating the green sheet transferred to the stage to be stacked, and
wherein the first energy is supplied from the first heating unit to the green sheet so that a sintering region to be sintered with the second energy supplied from the second heating unit in the green sheet supplied to the stage by the material supply unit is surrounded.

9. The three-dimensional forming apparatus according to claim 8,
wherein the sintering device includes a laser oscillator, a galvano device by which a laser beam from the laser oscillator is radiated to a predetermined radiation position, and a plurality of laser controllers controlling output energy of the laser beam with respect to the green sheet, and
wherein the galvano device includes a galvano mirror reflecting the laser beam and a mirror driving unit driving the galvano mirror to reflect the laser beam from the laser oscillator in a predetermined direction.

10. A three-dimensional forming apparatus comprising:
a control unit that serves as a control mechanism controlling a stage, a laser oscillator, a galvano device, a laser controller, and a material supply device.

11. The three-dimensional forming apparatus according to claim 10, wherein the control unit includes a controller operating in cooperation with a driving controller of the stage, a driving controller of the laser oscillator, a driving controller of the galvano device, a driving controller of the laser controller, and a driving controller of the material supply device.
